(19) United States
(12) Patent Application Publication
(10) Pub. No.: US 2025/0285311 A1
(43) Pub. Date: Sep. 11, 2025

(54) Bladder volume measurement device using parameter extraction

(71) Applicant: EDGECARE INC., Seoul (KR)

(72) Inventors: Yul Young PARK, Yongin-si (KR); Jung Jun KIM, Seoul (KR)

(21) Appl. No.: 18/931,487

(22) Filed: Oct. 30, 2024

(30) Foreign Application Priority Data
Mar. 7, 2024 (KR) 10-2024-0032583

(51) Int. Cl. G06T 7/62; G06T 7/00

(52) U.S. Cl. CPC G06T 7/62; G06T 7/0012; G06T 2207/10132; G06T 2207/30004

(57) ABSTRACT

A bladder volume measuring device includes a feature providing unit, a parameter determining unit, and a volume calculating unit. The feature providing unit may provide a plurality of feature factors for calculating a volume of a bladder included in an ultrasound image. The parameter determining unit may determine a selection parameter corresponding to some of the feature factors. The volume calculating unit may calculate the volume of the bladder according to the selection parameter. The bladder volume measurement device using parameter extraction according to the present invention may extract an optimal selection parameter using a parameter determining unit machine-learning a plurality of feature factors extracted to calculate a volume of a bladder included in an ultrasound image and measuring the volume of the bladder based on the selection parameter, thereby more accurately measuring the bladder volume.

### CROSS-REFERENCE TO RELATED APPLICATION(S)

This application claims benefit of priority to Korean Patent Application No. 10-2024-0032583 filed on Mar. 7, 2024 in the Korean Intellectual Property Office, the disclosure of which is incorporated herein by reference in its entirety.

### BACKGROUND

### 1. Field

The present disclosure relates to a bladder volume measurement device using parameter extraction.

### 2. Description of Related Art

Various types of parameters have been used to measure the bladder volumes of patients. Recently, various studies have been conducted to extract optimal parameters for measuring the bladder volumes more accurately.

### RELATED ART DOCUMENT

### Patent Document

(Korean Application Publication) No. 10-2023-0155190 (Publication date, 2023.11.10)

### SUMMARY

An aspect of the present disclosure may provide a bladder volume measurement device using parameter extraction capable of extracting an optimal selection parameter using a parameter determining unit machine-learning a plurality of feature factors extracted to calculate a volume of a bladder included in an ultrasound image and measuring the volume of the bladder based on the selection parameter, thereby more accurately measuring the bladder volume.

A bladder volume measuring device according to an embodiment of the present invention may include a feature providing unit, a parameter determining unit, and a volume calculating unit. The feature providing unit may provide a plurality of feature factors for calculating a volume of a bladder included in an ultrasound image. The parameter determining unit may determine a selection parameter corresponding to some of the feature factors. The volume calculating unit may calculate the volume of the bladder according to the selection parameter.

In an embodiment, the feature providing unit may include a first feature unit and a second feature unit. The first feature unit may provide a first feature factor calculated based on a maximum straight line, which is longest to cross a bladder region corresponding to the inside of a bladder border in the ultrasound image. The second feature unit may provide a second feature factor calculated based on a center point of the bladder region.

In an embodiment, the first feature unit may extract the first feature factor, while rotating by a predetermined first rotation angle around a midpoint corresponding to a center point of the maximum straight line.

In an embodiment, the second feature unit may extract the second feature factor, while rotating by a predetermined second rotation angle based on a center point of the bladder region.

In an embodiment, the first rotation angle may be greater than the second rotation angle.

In an embodiment, the feature providing unit may further include a third feature unit. The third feature unit may extract a third feature factor determined according to an area and circumference of the bladder included in the ultrasound image.

In an embodiment, the feature providing unit may further include a fourth feature unit. The fourth feature unit may extract a fourth feature factor determined according to patient information on a patient corresponding to the ultrasound image.

In an embodiment, the bladder volume measuring device may further include a priority determining unit. The priority determining unit may provide a priority for each of the plurality of feature factors.

In an embodiment, the bladder volume measuring device may further include a selection unit. The selection unit may select selection feature factors having the priority higher than a predetermined reference priority among the plurality of feature factors.

In an embodiment, the bladder volume measurement device may further include a weighting unit and a weight application unit. The weighting unit may provide a weight value determined according to the priority. The weight application unit may apply the weight value corresponding to the selection feature factors.

In addition to the technical problem of the present invention mentioned above, other features and advantages of the present invention are described below or may be clearly understood by a person having ordinary skill in the art to which the present invention belongs from such description and explanation.

According to the present disclosure as described above, the following effects are provided.

The bladder volume measurement device using parameter extraction according to the present invention may extract an optimal selection parameter using a parameter determining unit machine-learning a plurality of feature factors extracted to calculate a volume of a bladder included in an ultrasound image and measuring the volume of the bladder based on the selection parameter, thereby more accurately measuring the bladder volume.

In addition, other features and advantages of the present disclosure may be newly identified through the embodiments of the present disclosure.

### BRIEF DESCRIPTION OF DRAWINGS

FIG. 1 is a drawing illustrating a bladder volume measurement device according to embodiments of the present disclosure.

FIG. 2 is a drawing illustrating an example of a feature providing unit included in the bladder volume measurement device of FIG. 1.

FIGS. 3 and 4 are drawings illustrating an operation of the feature providing unit included in the bladder volume measurement device of FIG. 1.

FIG. 5 is a drawing illustrating another example of the feature providing unit included in the bladder volume measurement device of FIG. 1.

FIG. 6 is a drawing illustrating a priority determining unit and a selection unit included in the bladder volume measurement device of FIG. 1.

FIG. 7 is a drawing illustrating operations of the priority determining unit and the selection unit included in the bladder volume measurement device of FIG. 1.

FIGS. 8 and 9 are drawings illustrating operations of a weighting unit and a weight application unit included in the bladder volume measurement device of FIG. 1.

### DETAILED DESCRIPTION

In the specification, in adding reference numerals to components throughout the drawings, it is to be noted that like reference numerals designate like components even though components are shown in different drawings.

Meanwhile, meanings of the terms described in this specification should be understood as follows.

Terms of singular forms used herein are intended to include their plural forms unless explicitly indicated otherwise, and a scope of the present disclosure is not limited by the terms used herein.

It is to be understood that a term “include” or “have” does not preclude the presence or

addition of one or more other features, numerals, operations, components, parts or combinations thereof, which is mentioned in the specification.

Hereinafter, embodiments of the present disclosure are described in detail with reference to the accompanying drawings.

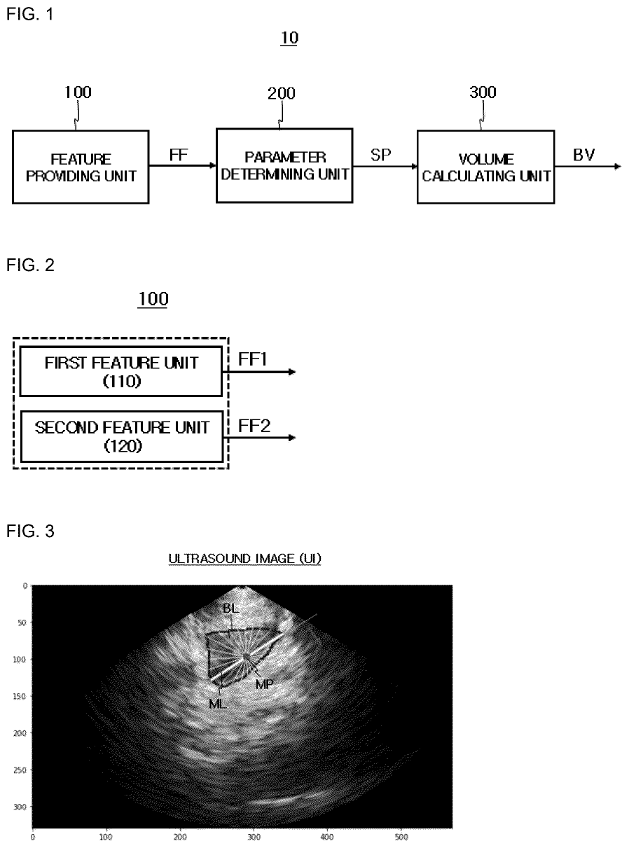

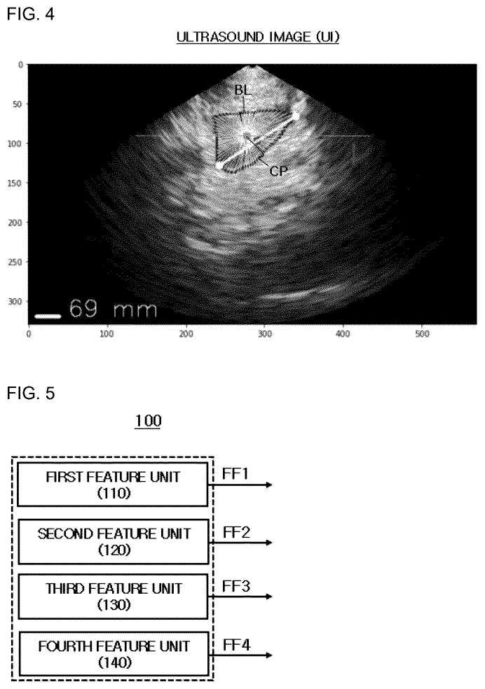

FIG. 1 is a drawing illustrating a bladder volume measurement device according to embodiments of the present disclosure, FIG. 2 is a drawing illustrating an example of a feature providing unit included in the bladder volume measurement device of FIG. 1, FIGS. 3 and 4 are drawings illustrating an operation of the feature providing unit included in the bladder volume measurement device of FIG. 1, and FIG. 5 is a drawing illustrating another example of the feature providing unit included in the bladder volume measurement device of FIG. 1.

Referring to FIGS. 1 to 5, a bladder volume measurement device 10 according to an embodiment of the present disclosure may include a feature providing unit 100, a parameter determining unit 200, and a volume calculating unit 300. The feature providing unit 100 may provide a plurality of feature factors FF for calculating a volume BV of a bladder included in an ultrasound image UI.

The feature providing unit 100 may include a first feature unit 110 and a second feature unit 120. The first feature unit 110 may provide a first feature factor FF1 calculated based on the maximum straight line ML, which is longest to cross a bladder region BL corresponding to the inside of a bladder border in the ultrasound image UI.

In an embodiment, the first feature unit 110 may extract the first feature factor FF1 by rotating by a predetermined first rotation angle around a midpoint MP corresponding to the center point of the maximum straight line ML. For example, as shown in FIG. 3, the bladder region BL corresponding to the inside of the bladder border may have various shapes. In this case, a line connecting two points with the longest distance between points arranged on the border of the bladder region BL may be the maximum straight line ML. Here, the center point that bisects the maximum straight line ML may be the midpoint MP.

In addition, for example, the predetermined first rotation angle may be 15 degrees. The straight lines connecting two points at which an extension line of the maximum straight line ML and the border of the bladder meet, while rotating the maximum straight line ML by 15 degrees around the midpoint MP may be included in the first feature factors FF1.

The second feature unit 120 may provide a second feature factor FF2 calculated based on the center point CP of the bladder region BL. In an embodiment, the second feature unit 120 may extract the second feature factor FF2, while rotating based on the center point CP of the bladder region BL by a predetermined second rotation angle.

For example, the center point CP of the bladder region BL may be set in various manners including user settings, and the predetermined second rotation angle may be 5 degrees. The straight lines connecting two points at which a base line and the border of the bladder region BL meet, while rotating 5 degrees based on a single base line passing through the center point CP of the bladder region BL may be included in the second feature factors FF2.

In an embodiment, the first rotation angle may be greater than the second rotation angle. For example, the first rotation angle may be 15 degrees, and the second rotation angle may be 5 degrees. Although the first rotation angle is described here as being greater than the second rotation angle, the present disclosure is not limited thereto and may also be applied to a case in which the first rotation angle is equal to or smaller than the second rotation angle.

In addition, although the present disclosure is described here using a sagittal image among ultrasound images UI for the bladder, the present disclosure is not limited thereto and may be applied to various ultrasound images.

In an embodiment, the feature providing unit 100 may further include a third feature unit 130. The third feature unit 130 may extract a third feature factor FF3 determined according to an area and circumference of the bladder included in the ultrasound image UI. For example, the third feature factor FF3 provided by the third feature unit 130 may include the area and circumference of the bladder included in the ultrasound image UI.

In an embodiment, the feature providing unit 100 may further include a fourth feature unit 140. The fourth feature unit 140 may extract a fourth feature factor FF4 determined according to patient information on a patient corresponding to the ultrasound image UI. For example, the fourth feature factor FF4 provided by the fourth feature unit 140 may include age, height, weight, etc. included in the patient information.

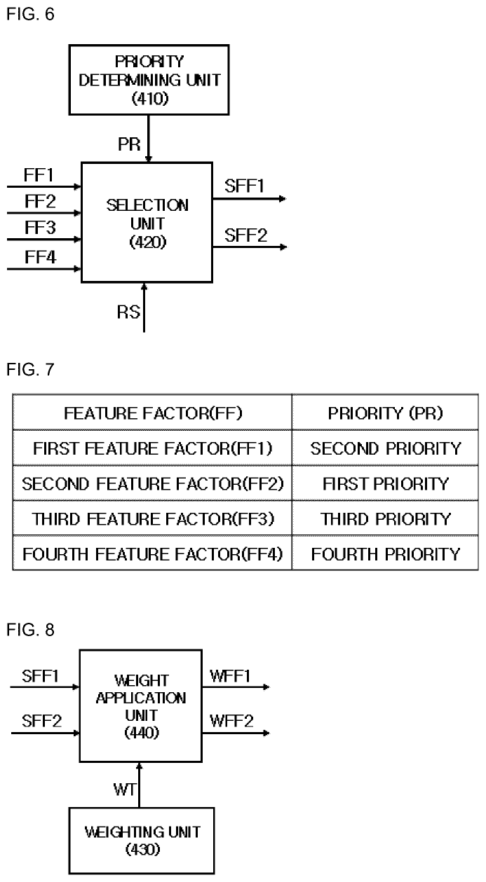

FIG. 6 is a drawing illustrating a priority determining unit and a selection unit included in the bladder volume measurement device of FIG. 1, and FIG. 7 is a drawing illustrating operations of the priority determining unit and the selection unit included in the bladder volume measurement device of FIG. 1.

Referring to FIGS. 1 to 7, in an embodiment, the bladder volume measurement device 10 may further include a priority determining unit 410. The priority determining unit 410 may provide a priority PR for each of a plurality of feature factors FF. The priority PR may be previously set in the priority determining unit 410 or may be determined according to a user input. For example, the plurality of feature factors FF may include a first feature factor FF1, a second feature factor FF2, a third feature factor FF3, and a fourth feature factor FF4. A first priority PR1 provided from the priority determining unit 410 may be the second feature factor FF2, and a second priority PR2 may be the first feature factor FF1. In addition, a third priority PR3 provided from the priority determining unit 410 may be the third feature factor FF3, and a fourth priority PR4 may be the fourth feature factor FF4.

In an embodiment, the bladder volume measurement device 10 may further include a selection unit 420. The selection unit 420 may select selection feature factors having a higher priority PR than a predetermined reference priority RS among a plurality of feature factors FF. For example, the predetermined reference priority RS may be the third priority PR3. In this case, the selection unit 420 may select the first feature factor FF1 of the second priority PR2 higher than the third priority PR3 of the reference rank RS and the second feature factor FF2 of the first priority PR1. Here, among the selection feature factors provided by the selection unit 420, a first selection feature factor SFF1 may be the second feature factor FF2 of the first priority PR1, and a second selection feature factor SFF2 of the selection feature factors may be the first feature factor FF1 of the second priority PR2.

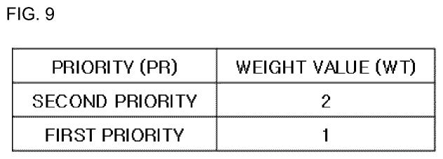

FIGS. 8 and 9 are drawings illustrating operations of the weighting unit and the weight application unit included in the bladder volume measurement device of FIG. 1.

Referring to FIGS. 1 to 9, in an embodiment, the bladder volume measurement device 10 may further include a weighting unit 430 and a weight application unit. The weighting unit 430 may provide a weight value WT determined according to the priority PR. For example, the first weight value WT1 applied to the first priority PR1 among the priorities PR may be 2, and the weight value WT applied to the second priority PR2 may be 1.

The weight application unit 440 may apply a weight value WT corresponding to the selection feature factors. For example, the first selection feature factor SFF1 corresponding to the first priority PR1 among the priorities PR may be the second feature factor FF2, and the second selection feature factor SFF2 corresponding to the second priority PR2 among the priorities PR may be the first feature factor FF1. In this case, the weight application unit 440 may provide a first weight factor by applying the first weight value WT1 of 2 to the second feature factor FF2 corresponding to the first priority PR1 and may provide a second weight factor by applying the second weight value WT2 of 1 to the first feature factor FF1 corresponding to the second priority PR2. In this case, the first weight factor WFF1 and the second weight factor WFF2 may be provided to the parameter determining unit 200.

The parameter determining unit 200 may determine a selection parameter SP corresponding to some of the feature factors FF. For example, the parameter determining unit 200 may include an artificial intelligence unit that provides the selection parameter SP for calculating an optimal bladder volume by machine-learning the feature factors FF and combinations of the feature factors FF. In addition, the parameter determining unit 200 may provide the optimal selection parameter SP also based on the weight factors provided from the weight application unit 440.

The volume calculating unit 300 may calculate the volume BV of the bladder according to the selection parameter SP. For example, the selection parameter SP may be the square of the maximum straight line ML and the second feature factor FF2 rotated by 5 degrees from the base line. In this case, the volume calculating unit 300 may calculate the volume BV of the bladder as a value obtained by multiplying the product of the square of the maximum straight line ML and the second feature factor FF2 rotated by 5 degrees from the base line by the weight selected by the weight application unit. Here, the volume BV of the bladder is expressed as the product of the square of the maximum straight line ML, the second feature factor FF2 rotated by 5 degrees from the base line, and the selected weight, but this may be only an example for describing the present disclosure.

The bladder volume measurement device 10 using parameter extraction according to the present invention may extract the optimal selection parameter SP using the parameter determining unit 200 machine-learning a plurality of feature factors FF extracted to calculate the volume BV of a bladder included in the ultrasound image UI and measuring the volume BV of the bladder based on the selection parameter SP, thereby more accurately measuring the bladder volume.

In addition to the aforementioned technical tasks of the present disclosure, other features and advantages of the present disclosure may be described below or may be clearly understood by those skilled in the art to which the present disclosure pertains from such description and explanation.

### DESCRIPTION OF REFERENCE NUMERALS

10: bladder volume measurement device 100: feature providing unit
200: parameter determining unit 300: volume calculating unit

What is claimed is:

1. A bladder volume measurement device comprising:
a feature providing unit configured to provide a plurality of feature factors for calculating a volume of a bladder included in an ultrasound image;
a parameter determining unit configured to determine a selection parameter corresponding to some of the feature factors; and
a volume calculating unit configured to calculate the volume of the bladder according to the selection parameter.

2. The bladder volume measurement device of claim 1, wherein
the feature providing unit includes:
a first feature unit configured to provide a first feature factor calculated based on a maximum straight line, which is longest to cross a bladder region corresponding to the inside of a bladder border in the ultrasound image; and
a second feature unit configured to provide a second feature factor calculated based on a center point of the bladder region.

3. The bladder volume measurement device of claim 2, wherein the first feature unit extracts the first feature factor, while rotating by a predetermined first rotation angle around a midpoint corresponding to a center point of the maximum straight line.

4. The bladder volume measurement device of claim 3, wherein the second feature unit extracts the second feature factor, while rotating by a predetermined second rotation angle based on a center point of the bladder region.

5. The bladder volume measurement device of claim 4, wherein the first rotation angle is greater than the second rotation angle.

6. The bladder volume measurement device of claim 5, wherein the feature providing unit further includes a third feature unit configured to extract a third feature factor determined based on an area and circumference of the bladder included in the ultrasound image.

7. The bladder volume measurement device of claim 6, wherein the feature providing unit further includes a fourth feature unit configured to extract a fourth feature factor determined according to patient information on a patient corresponding to the ultrasound image.

8. The bladder volume measurement device of claim 7, further comprising:
a priority determining unit configured to provide a priority for each of the plurality of feature factors.

9. The bladder volume measurement device of claim 8, further comprising:
a selection unit configured to select selection feature factors having a priority higher than a predetermined reference priority among the plurality of feature factors.

10. The bladder volume measurement device of claim 9, further comprising:
a weighting unit configured to provide a weight value determined according to the priority; and
a weight application unit configured to apply the weight value corresponding to the selection feature factors.
